(19) United States
(12) Patent Application Publication
(10) Pub. No.: US 2022/0384909 A1
(43) Pub. Date: Dec. 1, 2022

(54) THERMALLY STABLE POLYMER-BASED COMPOSITE SEPARATOR FOR A LITHIUM SECONDARY BATTERY AND MANUFACTURING METHOD

(71) Applicant: Global Graphene Group, Inc., Dayton, OH (US)

(72) Inventor: Bor Z. Jang, Centerville, OH (US)

(21) Appl. No.: 17/319,197

(22) Filed: May 13, 2021

(51) Int. Cl. H01M 50/446; H01M 50/443; H01M 10/0525; H01M 50/403

(52) U.S. Cl. CPC H01M 50/446; H01M 50/443; H01M 10/0525; H01M 50/403

(57) ABSTRACT

A lithium secondary battery comprising a cathode, an anode, and a thermally stable polymer composite separator disposed between the cathode and the anode, wherein the polymer composite separator comprises (i) a thermally stable polymer; (ii) from 0.1% to 30% by weight of a lithium salt dispersed in the thermally stable polymer; and (iii) from 30% to 99% by weight of particles of an inorganic material wherein the inorganic material particles are dispersed in or bonded by the thermally stable polymer and the composite separator has a thickness from 50 nm to 100 μm and a lithium ion conductivity from 10⁻⁸ S/cm to 5×10⁻² S/cm at room temperature. Also provided are the thermally stable and ion-conducting polymer composite separators and a process for producing such a separator.

### FIELD

The present disclosure relates to the rechargeable lithium battery field, including the lithium-ion battery and lithium metal battery, and, in particular, to an anode-less rechargeable lithium metal battery having no lithium metal as an anode active material initially when the battery is made and a method of manufacturing same.

### BACKGROUND

Lithium-ion and lithium (Li) metal cells (including Lithium-sulfur cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li_{4.4}Si) as an anode active material. Hence, in general, rechargeable Li metal batteries have a significantly higher energy density than lithium-ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated. Unfortunately, upon cycling, the lithium metal resulted in the formation of dendrites that ultimately caused unsafe conditions in the battery. As a result, the production of these types of secondary batteries was stopped in the early 1990′s giving ways to lithium-ion batteries.

Even now, cycling stability and safety concerns remain the primary factors preventing the further commercialization of Li metal batteries for EV, HEV, and microelectronic device applications. These issues are primarily due to the high tendency for Li to form dendrite structures during repeated charge-discharge cycles or an overcharge, leading to internal electrical shorting and thermal runaway. Many attempts have been made to address the dendrite-related issues, as briefly summarized below:

Fauteux, et al. [D. Fauteux, et al., “Secondary Electrolytic Cell and Electrolytic Process,” U.S. Pat. No. 5,434,021, Jul. 18, 1995] applied to a metal anode a protective surface layer (e.g., a mixture of polynuclear aromatic and polyethylene oxide) that enables transfer of metal ions from the metal anode to the electrolyte and back. The surface layer is also electronically conductive so that the ions will be uniformly attracted back onto the metal anode during electrodeposition (i.e. during battery recharge). Alamgir, et al. [M. Alamgir, et al. “Solid polymer electrolyte batteries containing metallocenes,” U.S. Pat. No. 5,536,599, Jul. 16, 1996] used ferrocenes to prevent chemical overcharge and dendrite formation in a solid polymer electrolyte-based rechargeable battery.

Skotheim [T. A. Skotheim, “Stabilized Anode for Lithium-Polymer Battery,” U.S. Pat. No. 5,648,187 (Jul. 15, 1997); U.S. Pat. No. 5,961,672 (Oct. 5, 1999)] provided a Li metal anode that was stabilized against the dendrite formation by the use of a vacuum-evaporated thin film of a Li ion-conducting polymer interposed between the Li metal anode and the electrolyte. Skotheim, et al. [T. A. Skotheim, et al. “Lithium Anodes for Electrochemical Cells,” U.S. Pat. No. 6,733,924 (May 11, 2004); U.S. Pat. No. 6,797,428 (Sept. 28, 2004); U.S. Pat. No. 6,936,381 (Aug. 30, 2005); and U.S. Pat. No. 7,247,408 (Jul. 24, 2007)] further proposed a multilayer anode structure consisting of a Li metal-based first layer, a second layer of a temporary protective metal (e.g., Cu, Mg, and Al), and a third layer that is composed of at least one layer (typically 2 or more layers) of a single ion-conducting glass, such as lithium silicate and lithium phosphate, or polymer. It is clear that such an anode structure, consisting of at least 3 or 4 layers, is too complex and too costly to make and use.

Protective coatings for Li anodes, such as glassy surface layers of LiI-Li₃PO₄-P₂S₅, may be obtained from plasma assisted deposition [S. J. Visco, et al., “Protective Coatings for Negative Electrodes,” U.S. Pat. No. 6,025,094 (Feb. 15, 2000)]. Complex, multi-layer protective coatings were also proposed by Visco, et al. [S. J. Visco, et al., “Protected Active Metal Electrode and Battery Cell Structures with Non-aqueous Interlayer Architecture,” U.S. Pat. No. 7,282,295 (Oct. 16, 2007); U.S. Pat. No. 7,282,296 (Oct. 16, 2007); and U.S. Pat. No. 7,282,302 (Oct. 16, 2007)].

Despite these earlier efforts, no rechargeable Li metal batteries have yet succeeded in the marketplace. This is likely due to the notion that these prior art approaches still have major deficiencies. For instance, in several cases, the anode or electrolyte structures are too complex. In others, the materials are too costly or the processes for making these materials are too laborious or difficult. Conventional solid electrolytes typically have a low lithium ion conductivity, are difficult to produce and difficult to implement into a battery.

Furthermore, the conventional solid electrolyte, as the sole electrolyte in a cell or as an anode-protecting layer (interposed between the lithium film and another electrolyte) does not have and cannot maintain a good contact with the lithium metal. This reduces the effectiveness of the electrolyte to support dissolution of lithium ions (during battery discharge), transport lithium ions, and allowing the lithium ions to re-deposit back to the lithium anode (during battery recharge). A ceramic separator that is disposed between an anode active material layer (e.g. a graphite-based anode layer or a lithium metal layer) and a cathode active layer suffers from the same problems as well. In addition, a ceramic separator also has a poor contact with the cathode layer if the electrolyte in the cathode layer is a solid electrolyte (e.g., inorganic solid electrolyte).

Another major issue associated with the lithium metal anode is the continuing reactions between liquid electrolyte and lithium metal, leading to repeated formation of “dead lithium-containing species” that cannot be re-deposited back to the anode and become isolated from the anode. These reactions continue to irreversibly consume electrolyte and lithium metal, resulting in rapid capacity decay. In order to compensate for this continuing loss of lithium metal, an excessive amount of lithium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

Clearly, an urgent need exists for a simpler, more cost-effective, and easier to implement approach to preventing Li metal dendrite-induced internal short circuit and thermal runaway problems in Li metal batteries, and to reducing or eliminating the detrimental reactions between lithium metal and the electrolyte.

Hence, an object of the present disclosure was to provide an effective way to overcome the lithium metal dendrite and reaction problems in all types of Li metal batteries having a lithium metal anode. A specific object of the present disclosure was to provide a lithium cell (either lithium-ion cell or lithium metal cell) that exhibits a high specific capacity, high specific energy, high degree of safety, and a long and stable cycle life.

### SUMMARY

The present disclosure provides a lithium secondary battery comprising a cathode, an anode, and a thermally stable polymer composite separator disposed between the cathode and the anode, wherein the composite separator comprises (i) a thermally stable polymer; (ii) from 0.1% to 30% by weight of a lithium salt dispersed in the thermally stable polymer; and (iii) from 30% to 99% (preferably >60%, more preferably >70%, and further preferably >80% by weight) by weight of particles of an inorganic material, wherein the composite separator has a thickness from 50 nm to 100 μm (preferably from 1 to 20 μm and more preferably thinner than 10 μm) and a lithium-ion conductivity from 10⁻⁸ S/cm to 5×10⁻² S/cm at room temperature and wherein the thermally stable polymer is selected from the group consisting of polyimide, poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly [2,2′-(m-phenylene)-5,5′-bibenzimidazole], poly(arylene ethers), polycarboranes, poly (p-xylyhene), poly(phenylene ether), polymers from 1,4,5,8-naphthalenetetracarboxylic acid and aromatic tetraamines, poly1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof. Sulfonation is herein found to impart improved lithium-ion conductivity to a polymer.

In certain embodiments, the inorganic material comprises particles of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof. Alternatively or additionally, the inorganic material particles may comprise a material selected from a transition metal oxide, aluminum oxide, silicon dioxide, transition metal sulfide, transition metal selenide, alkylated ceramic particles, metal phosphate, metal carbonate, or a combination thereof.

In certain embodiments, the disclosure provides a lithium secondary battery comprising a cathode, an anode, and a thermally stable polymer composite separator disposed between the cathode and the anode, wherein the composite separator comprises (i) a thermally stable polymer and (ii) from 30% to 99% by weight of particles of an inorganic solid material (e.g., inorganic electrolyte material), wherein the composite separator has a thickness from 50 nm to 100 μm and a lithium-ion conductivity from 10⁻⁸ S/cm to 5×10⁻² S/cm at room temperature and wherein the thermally stable polymer is selected from the group consisting of poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzo-phenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof. The preferably inorganic solid electrolyte material is selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

The thermally stable polymer may form a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polymethyl acrylate, polymethyl methacrylate, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃) , lithium bisperfluoro-ethylsulfonylimide (LiB ETI), lithium bis(trifluoromethanesulfonyl)imide, lithium bis(fluorosulfonyl)imide, lithium trifluoromethanesulfonimide (LiTFSI), an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4, or a combination thereof.

In certain embodiments, the anode in the lithium secondary battery has an amount of lithium or lithium alloy as an anode active material supported by an anode current collector. In certain other embodiments, initially the anode has no lithium or lithium alloy as an anode active material supported by the anode current collector when the battery is made and prior to a charge or discharge operation of the battery. This latter configuration is referred to as an anode-less lithium battery. During the first battery charge operation, lithium ions come out of the cathode active material, move to the anode, and deposit onto a surface of the anode current collector.

In certain embodiments, the battery is a lithium-ion battery and the anode has an anode current collector and a layer of an anode active material supported by the anode current collector, wherein the anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

The anode current collector may be selected from, for instance, a Cu foil, a Cu-coated polymer film, a sheet of Ni foam, a porous layer of nano-filaments, such as graphene sheets, carbon nanofibers, carbon nano-tubes, etc.

Preferably, the inorganic material comprises an inorganic solid electrolyte material (dispersed in the thermally stable polymer composite separator layer) is in a fine powder form having a particle size preferably from 10 nm to 30 μm, more preferably from 50 nm to 1 μm. The inorganic solid electrolyte material may be selected from an oxide type, sulfide type, hydride type, halide type, borate type, phosphate type, lithium phosphorus oxynitride. (LiPON), Garnet-type, lithium superionic conductor (LISICON), sodium superionic conductor (NASICON), or a combination thereof. These solid electrolyte particles can improve the lithium ion transport rates of the composite separator.

In some embodiments, the inorganic material particles comprise a material selected from a transition metal oxide (e.g., TiO₂), aluminum oxide, silicon dioxide, transition metal sulfide, transition metal selenide, alkylated ceramic particles, metal phosphate, metal carbonate, or a combination thereof. These particles act to stop the penetration of any potential lithium dendrite that otherwise could cause internal shorting.

The thermally stable polymer may further comprise from 0.1% to 50% by weight of a lithium ion-conducting additive, which is different from the inorganic solid electrolyte particles.

In some embodiments, this thermally stable polymer composite layer may be a thin film disposed against a surface of an anode current collector. The anode contains a current collector without a lithium metal or any other anode active material, such as graphite or Si particles, when the battery cell is manufactured. Such a battery cell having an initially lithium metal-free anode is commonly referred to as an “anode-less” lithium battery. The lithium ions that are required for shuttling back and forth between the anode and the cathode are initially stored in the cathode active materials (e.g. Li in LiMn₂O₄ and LiMPO₄, where M=Ni, Co, F, Mn, etc.). During the first battery charge procedure, lithium ions (Li⁺) come out of the cathode active material, move through the electrolyte and then through the presently disclosed protective high-elasticity polymer layer and get deposited on a surface of the anode current collector. As this charging procedure continues, more lithium ions get deposited onto the current collector surface, eventually forming a lithium metal film or coating.

In certain embodiments, the thermally stable polymer further contains a reinforcement material dispersed therein wherein the reinforcement material is selected from a polymer fiber, a glass fiber, a ceramic fiber or nano-flake (e.g., nano clay flakes), or a combination thereof. The reinforcement material preferably has a thickness or diameter less than 100 nm.

The working electrolyte in the lithium battery may be selected from an organic liquid electrolyte, ionic liquid electrolyte, polymer gel electrolyte, solid polymer electrolyte, inorganic solid-state electrolyte, quasi-solid electrolyte having a lithium salt dissolved in an organic or ionic liquid with a lithium salt concentration higher than 2.0 M, or a combination thereof.

At the anode side, preferably and typically, the thermally stable polymer composite for the protective layer has a lithium-ion conductivity no less than 10⁻⁵ S/cm, more preferably no less than 10⁻⁴ S/cm, and most preferably no less than 10⁻³ S/cm.

The cathode active material may be selected from an inorganic material, an organic material, a polymeric material, or a combination thereof. The inorganic material may be selected from a metal oxide, metal phosphate, metal silicide, metal selenide (e.g., lithium polyselides for use in a Li-Se cell), metal sulfide (e.g., lithium polysulfide for use in a Li-S cell), or a combination thereof. Preferably, these cathode active materials contain lithium in their structures; otherwise, the cathode must contain a lithium source.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The cathode active material is preferably in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. Further preferably, the cathode active material has a dimension less than 50 nm, even more preferably less than 20 nm, and most preferably less than 10 nm. In some embodiments, one particle or a cluster of particles may be coated with or embraced by a layer of carbon disposed between the particle(s) and/or a high-elasticity polymer layer (an encapsulating shell).

The cathode layer may further contain a graphite, graphene, or carbon material mixed with the cathode active material particles. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The cathode active material particles may be coated with or embraced by a conductive protective coating, which is selected from a carbon material, graphene, electronically conductive polymer, conductive metal oxide, or conductive metal coating.

In certain embodiments, the polymer composite separator layer has two primary surfaces with a first primary surface facing the anode side and a second primary surface opposing or opposite to the first primary surface and wherein the inorganic material particles (e.g., inorganic solid electrolyte powder) has a first concentration at the first surface and a second concentration at the second surface and the first concentration is greater than the second concentration. In other words, there are more inorganic particles at the anode side of the polymer composite layer than the opposite side intended to be facing the cathode. There is a concentration gradient across the thickness of the elastic composite separator layer. The high concentration of inorganic solid particles on the anode side (preferably >30% by weight and more preferably >60% by weight) can help stop the penetration of any lithium dendrite, if formed, and help to form a stable artificial solid-electrolyte interphase (SEI). Thus, in some embodiments, the composite separator has a gradient concentration of the inorganic solid particles across the thickness of the separator.

The disclosure also provides a polymer composite separator for use in a lithium battery. The polymer composite separator comprises: (i) a thermally stable polymer; (ii) from 0.1% to 30% by weight of a lithium salt dispersed in the thermally stable polymer; and (iii) from 30% to 99% by weight of particles of an inorganic material wherein the particles are dispersed in or bonded by the thermally stable polymer and the composite separator has a thickness from 50 nm to 100 μm and a lithium ion conductivity from 10⁻⁸ S/cm to 5×10⁻² S/cm at room temperature and wherein the thermally stable polymer is selected from the group consisting of polyimide, poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1,3,4-oxadiazoles), poly(1,2,4oxa-diazoles), poly(1,2,4- and 1,2,5-oxadiazole-N-oxides), polythiadiazoles, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod polymers, ladder polymers, sulfonated versions thereof, and combinations thereof.

The inorganic material may comprise particles of an inorganic solid electrolyte material selected from an oxide type, sulfide type, hydride type, halide type, borate type, phosphate type, lithium phosphonis oxynitride (LiPON), Garnet-type, lithium superionic conductor (LISICON) type, sodium superionic conductor (NASICON) type, or a combination thereof.

In some embodiments, the inorganic material particles comprise a material selected from a transition metal oxide, aluminum oxide, silicon dioxide, transition metal sulfide, transition metal selenide, alkylated ceramic particles, metal phosphate, metal carbonate, or a combination thereof.

The lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4, or a combination thereof. This lithium ion-conducting additive is dispersed in the matrix of the thermally stable polymer.

Preferably, the thermally stable polymer forms a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The disclosure also provides a process for manufacturing a thermally stable polymer composite separator, the process comprising (A) dispersing particles of an inorganic solid material and a lithium salt in a liquid reactive mass of a polymer precursor to a thermally stable polymer to form a slurry; (B) dispensing and depositing a layer of the liquid reactive mass onto a solid substrate surface; and (C) polymerizing and/or crosslinking the polymer precursor in the reactive mass to form a layer of the polymer composite separator. This polymer precursor may comprise a monomer, an oligomer, or an uncured (but curable) polymer possibly dissolved in a liquid solvent where necessary. This precursor is subsequently cured (polymerized and/or crosslinked).

This solid substrate can be a glass surface, a polymer film surface, a metal foil surface, etc. in order to form a free-standing film for a polymer composite separator. In certain preferred embodiments, the solid substrate may be an anode current collector, an anode active material layer, or a cathode active material layer. In other words, this polymer composite separator can be directly deposited onto a layer of anode active material, an anode current collector, or a layer of cathode active material. This is achievable because curing of the polymer does not require a high temperature; curing temperature being typically lower than 300° C. or even lower than 100° C. This is in stark contrast to the typically 900-1,200° C. required of sintering an inorganic solid electrolyte to form a ceramic separator. In addition, the presently disclosed polymer composite separator is at least as good as a ceramic separator in terms of reducing interfacial impedance and stopping dendrite penetration.

Preferably, the process is a roll-to-roll process wherein step (B) comprises (i) continuously feeding a layer of the solid substrate (e.g. flexible metal film, plastic film, etc.) from a feeder roller to a dispensing zone where the reactive mass is dispensed and deposited onto the solid substrate to form a continuous layer of the reactive mass; (ii) moving the layer of the reactive mass into a reacting zone where the reactive mass is exposed to heat, ultraviolet (UV) light, or high-energy radiation (e.g., electron beam, gamma radiation, etc.) to polymerize and/or cure the reactive mass to form a continuous layer of polymer composite; and (iii) collecting the polymer composite on a winding roller. This process is conducted in a reel-to-reel manner.

The process may further comprise cutting and trimming the layer of polymer composite into one or multiple pieces of composite separators.

The process may further comprise combining an anode, the polymer composite separator, an electrolyte, and a cathode electrode to form a lithium battery.

If desirable, the resulting elastic composite separator may be soaked in or impregnated with an organic or ionic liquid electrolyte.

### BRIEF DESCRIPTION OF THE DRAWINGS

FIG. 1 Schematic of a prior art lithium metal battery cell, containing an anode layer (a thin Li foil or Li coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2 Schematic of a presently invented lithium metal battery cell (upper diagram) containing an anode current collector (e.g., Cu foil) but no anode active material (when the cell is manufactured or in a fully discharged state), a polymer composite separator, and a cathode active material layer, which is composed of particles of a cathode active material, a conductive additive (not shown) and a resin binder (not shown). A cathode current collector supporting the cathode active layer is also shown. The lower diagram shows a thin lithium metal layer deposited between the Cu foil and the composite separator layer when the battery is in a charged state.

FIG. 3(A) Schematic of a polymer composite separator layer wherein the inorganic solid electrolyte particles are uniformly dispersed in a matrix of a thermally stable polymer according to some embodiments of the present disclosure;

FIG. 3(B) Schematic of a polymer composite separator layer wherein the inorganic solid electrolyte particles are preferentially dispersed near one surface (e.g., facing the anode side) of a polymer composite separator layer; the opposing surface has a lower or zero concentration of the inorganic solid electrolyte particles, according to some embodiments of the present disclosure.

FIG. 3(C) Schematic of a polymer composite separator layer wherein the inorganic solid electrolyte particles are preferentially dispersed at the core of a polymer composite separator layer; the outer regions have a lower or zero concentration of the inorganic solid electrolyte particles, according to some embodiments of the present disclosure.

FIG. 4 Schematic of a roll-to-roll process for producing rolls of elastic composite separator in a continuous manner.

### DETAILED DESCRIPTION

This disclosure is related to a lithium secondary battery, which is preferably based on a working electrolyte selected from an organic electrolyte, a polymer gel electrolyte, a solid polymer electrolyte, an ionic liquid electrolyte, a quasi-solid electrolyte, or an inorganic solid-state electrolyte in the anode and/or the cathode. The anode and the cathode are separated by a solid-state polymer composite separator. The shape of a lithium secondary battery can be cylindrical, square, prismatic, pouch, button-like, etc. The present disclosure is not limited to any battery shape or configuration or any type of electrolyte.

The present disclosure provides a lithium secondary battery comprising a cathode, an anode, and a thermally stable polymer composite separator disposed between the cathode and the anode, wherein the composite separator comprises (i) a thermally stable polymer; (ii) from 0.1% to 30% by weight of a lithium salt dispersed in the thermally stable polymer; and (iii) from 30% to 99% (preferably >60%, more preferably >70%, and further preferably >80% by weight) by weight of particles of an inorganic material, wherein the composite separator has a thickness from 50 nm to 100 μm (preferably from 1 to 20 μm and more preferably thinner than 10 μm) and a lithium-ion conductivity from 10⁻⁸ S/cm to 5×10⁻² S/cm at room temperature and wherein the thermally stable polymer is selected from the group consisting of polyimide, poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers) polycarboranes, poly (p-xylylene), poly(phenylene ether), polymers from 1,4,5,8-naphthalenetetracarboxylic acid and aromatic tetraamines, poly(1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof. Sulfonation is herein found to impart improved lithium-ion conductivity to a polymer.

These thermally stable polymers have a high thermo-oxidative degradation temperature, typically having a degradation temperature higher than 250° C., more typically higher than 300° C., further typically higher than 350° C., some even higher than 400° C., or higher than 450° C.). However, these polymers of high thermal stability are not known to have a high lithium-ion conductivity and, hence, not believed to be useful as a separator material in a lithium battery. The incorporation of from 0.1% to 30% by weight of a lithium salt in the thermally stable polymer can significantly increase the lithium-ion conductivity of the polymer composite. The use of particles of an inorganic solid electrolyte material can also significantly increase the ion conductivity.

In certain embodiments, the inorganic material comprises particles of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof. Alternatively or additionally, the inorganic material particles may comprise a material selected from a transition metal oxide, aluminum oxide, silicon dioxide, transition metal sulfide, transition metal selenide, alkylated ceramic particles, metal phosphate, metal carbonate, or a combination thereof.

In certain embodiments, the disclosure provides a lithium secondary battery comprising a cathode, an anode, and a thermally stable polymer composite separator disposed between said cathode and said anode, wherein said composite separator comprises (i) a thermally stable polymer and (ii) from 30% to 99% by weight of particles of an inorganic solid electrolyte material, wherein the composite separator has a thickness from 50 nm to 100 μm and a lithium-ion conductivity from 10⁻⁸ S/cm to 5×10⁻² S/cm at room temperature and wherein the thermally stable polymer is selected from the group consisting of poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzo-phenanthroline) ladders (BBL), poly(imidazoisoquinoline) ladders, polydicyclopentadiene (pDCPD), polyether ether ketone (PEEK), polyimide, rigid-rod and ladder polymers, sulfonated versions thereof, and combinations thereof and wherein the inorganic solid electrolyte material is selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

Several examples of thermally stable polymers will be briefly discussed in what follows: Polyimide (PI) is a polymer of imide monomers belonging to the class of thermally stable polymers. A classic polyimide is Kapton, which is produced by condensation of pyromellitic dianhydride and 4,4′-oxydianiline. Polyimides exist in two formats: thermosetting and thermoplastic. Depending upon the constitution of their main chain, polyimide can be classified as aliphatic, aromatics, semi-aromatics. PIs can be thermoplastics or thermosets. Aromatic polyimides are derived from an aromatic dianhydride and diamine.

Semi-aromatic PIs contain any one of the monomer aromatics: i.e., either the dianhydride or diamine is aromatic, and the other part is aliphatic. Aliphatic polyimides consist of the polymers formed as a result of the combination of aliphatic dianhydride and diamine. Some examples of PI structures are given below:

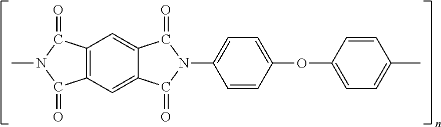

### Molecular Structure of Aromatic Polyimide

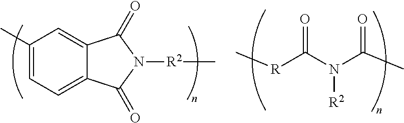

### Aromatic Heterocyclic Polyimide (L); Linear Polyimide (R)

Several methods can be used to prepare polyimides; e.g., (i) the reaction between a dianhydride and a diamine (the most used method) and (ii) the reaction between a dianhydride and a diisocyanate. The desired lithium salt may be added into either or both the reactants, or the resultant oligomers. One may also add the lithium salt into the intermediate poly(amid acid).

The polymerization of a diamine and a dianhydride can be conducted by a two-step method in which a poly(amid acid) is prepared first or directly by a one-step method. The two-step method is the most widely used procedure for polyimide synthesis. At first a soluble poly(amic acid) is prepared which is cyclized after further processing in a second step to the polyimide. A two-step process is necessary because the final polyimides are in most cases infusible and insoluble due to their aromatic structure.

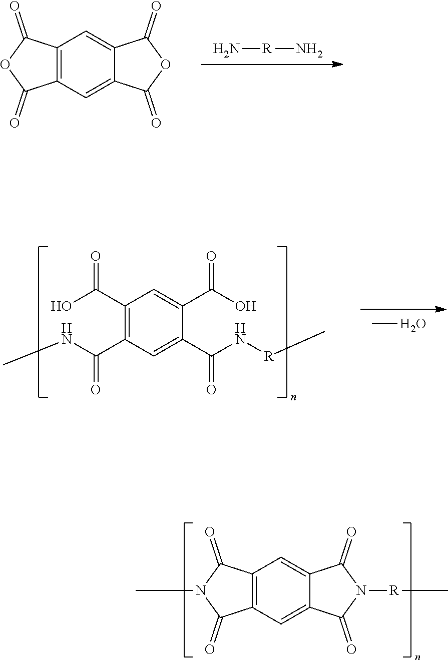

Dianhydrides used as precursors to these materials include pyromellitic dianhydride, benzoquinonetetracarboxylic dianhydride and naphthalene tetracarboxylic dianhydride. Common diamine building blocks include 4,4′-diaminodiphenyl ether (“DAPE”), meta-phenylene diamine (“MDA”), and 3,3-diaminodiphenylmethane. Hundreds of diamines and dianhydrides have been examined to tune the physical and especially the processing properties of PIs. These materials tend to be insoluble and have high softening temperatures, arising from charge-transfer interactions between the planar subunits

Highly soluble phenylethynyl-endcapped isoimide oligomers can be synthesized using 2,3,3′,4′-biphenyltetracarboxylic dianhydride (3,4′-BPDA) and aromatic diamines as the monomers, 4-phenylethynyl phthalic anhydride (4-PEPA) as the end-capping reagent, and trifluoroacetic anhydride as the dehydrating agent. Subsequently, thermosetting polyimides and PI composites can be produced from these oligomers via the thermal crosslinking reaction of the phenylethylnyl group. The composite separator layers may be produced by adding a desired amount of inorganic filler (e.g., SiO₂ nano particles or particles of a solid inorganic electrolyte) in the oligomer.

For instance, a series of isoimide oligomers with different molecular weights and a variety of chemical architectures can be prepared by polycondensation of 3,4′-BPDA, 4-PEPA, and aromatic diamines including m-phenylenediamine (m-PDA), 2,2′-bis(trifluoromethyl) benzidine (TFMB), and 3,4′-oxydianiline (3,4′-ODA), followed by cyclization with trifluoroacetic anhydride. Compared to their imide analogues, isoimide oligomers can exhibit much higher solubility in low boiling point solvents, and slightly lower melt viscosity. These resins can be formulated into thermosetting polyimides and composites by thermal crosslinking of the phenylethynyl group and conversion from isoimide to imide at elevated temperatures. The cured polyimides can exhibit extremely high glass transition temperatures (T_{g}) up to 467° C., and 5% weight loss temperatures (T_{5%}) up to 584° C. in a nitrogen atmosphere. The polyimide-inorganic filler composites can possess high glass transition temperatures and thermal stability.

Poly[2,2′-(m-phenylene)-5,5′-bibenzimidazole] (PBI) is a thermally stable polymer synthesized from tetra-aminobiphenyl-(3,3′-diaminobenzidine) and diphenyl isophthalate. It is used in different forms, such as fibers, composites, and neat resin, primarily for high-temperature applications. PBI has excellent dimensional stability at high temperatures, and it emits very little smoke when it is exposed to extremely high temperatures. This feature is particularly helpful for lithium battery applications. It is resistant to chemicals, and it retains its integrity even when charred.

Polyquinolines are versatile, thermally stable polymers and are characterized by repeating quinoline units, which display a catenation pattern of 2,6, 2,4, or 3,6 units. Polyquinolines are formed by the step-growth polymerization of o-aminophenyl ketone monomers and ketone monomers containing a hydrogens (mostly acetophenone derivatives):

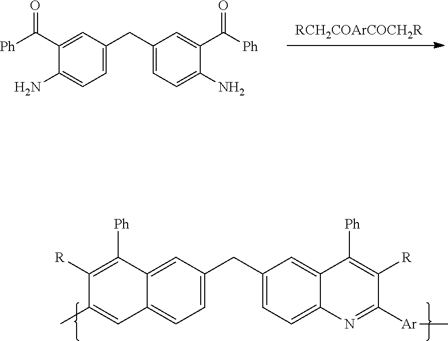

Alternatively, they may be prepared by the Friedländer reaction , which involves either an acid- or a base-catalyzed condensation of an o-aminoaromatic aldehyde or ketone with a ketomethylene compound. Polyquinolines have also been obtained by a postpolymerization thermal treatment of poly(enaminonitriles). The resulting polymers show excellent thermal stability, with initial weight losses occurring between 500° C. and 600° C. in air.

Polyimide is an important thermally stable polymer. Wide variations of the monomers and the precursors make polyimide a suitable candidate to be used as one component of a polymer alloy. For instance, polymer alloys of a polybenzoxazine and a polyimide was prepared by blending B-a (see the figure below) as a benzoxazine with a poly(amide acid), PAA, as a precursor of polyimide, followed by film casting and thermal treatment for the ring-opening polymerization of the benzoxazine and imidization.

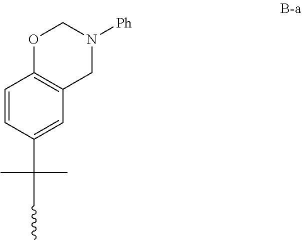

Various types of PAA were prepared as shown in the below figure:

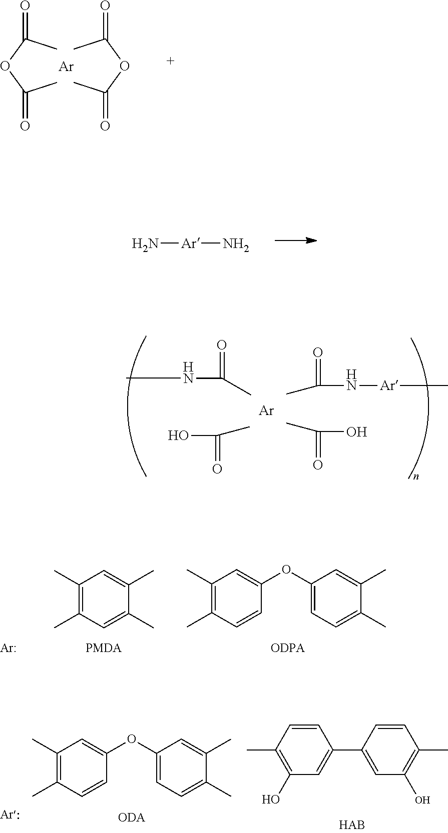

The onset temperature of the exotherm due to the ring-opening polymerization can decrease by as much as ˜80° C. by blending B-a with a PAA because of the catalytic effect of the carboxylic group in the PAA. The resulting alloy films are considered to form a semi-interpenetrating polymer network (semi-IPN) consisting of a linear polyimide and a crosslinked polybenzoxazine or to form an AB-co-crosslinked polymer network by the copolymerization of benzoxazine with polyimide containing a pendent phenolic hydroxyl:

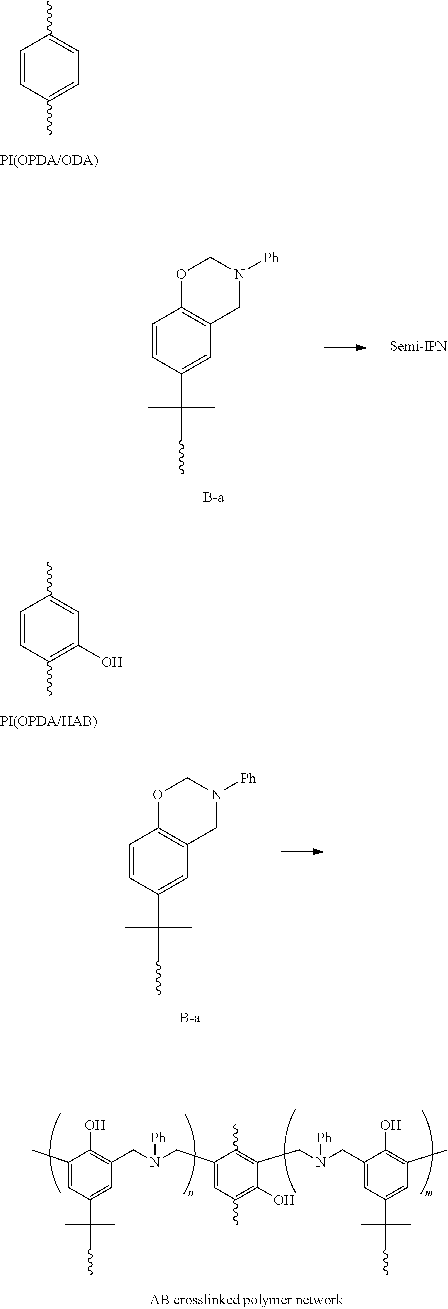

The semi-IPN polymers gave two T_{g}s, while the AB-co-crosslinked polymers gave only one T_{g}. Both types of polymer alloys were effective to improve the brittleness, the T_{g} and the thermal degradation temperature of polybenzoxazine. The semi-IPN formation was especially effective for toughening the polybenzoxazine, while the AB-co-crosslinked polymer network was effective for increasing T_{g}.

Another type of thermally stable polymers is polyphthalonitrile resins. Intensive investigations on high-temperature polymers have led to the development of a broad array of therrmooxidatively stable materials. Phthalonitrile resins are an addition to this unique class of addition-curable, high-temperature polymeric material. Structural modifications through the incorporation of thermally stable groups such as fluorine, imide, and benzoxazine enable the development of resin systems with tunable properties. The structure-property relationship in these polymers, the role of different curatives, the processability, and the corresponding cross-linking mechanisms have been studied. The scenario of self-cure-promoting phthalonitriles has been proposed that would accelerate the long cure schedule required to attain the complete nitrile curing.

Polycondensations of 1,4,5,8-naphthalenetetracarboxylic acid (NTCA) with both 3,3′-diaminobenzidine (DAB) and 1,2,4,5-tetraaminobenzene tetrahydrochloride (TAB) in polyphosphoric acid (PPA) were found to produce soluble polymers which exhibit excellent thermal stabilities. The solubility in certain solvents is a good feature in the production of polymer matrix composite separator layers. Polymer derived from TAB had a ladder-type structure. Polymers with solution viscosities near 1 or above (determined in H₂SO₄) can be obtained from polymerizations near 200° C., and analysis showed these to possess a very high degree of completely cyclized benzimidazo-benzophenanthroline structure. Less vigorous reaction conditions gave polymers with lower solution viscosities which appeared to be less highly cyclized. Low-viscosity polymer can be prepared from DAB and NTCA by solid-phase polycondensation. Some advancements in the solution viscosities of polymers synthesized from DAB in PPA were caused by second staging in the solid phase.

Another useful class of thermally stable polymers is the ladder polymers. The synthesis of ladder polymers has been performed via Diels-Alder reactions, and based on Tröger's base formation and double aromatic nucleophilic substitution. Many of the synthetic methods result in relatively flexible linkages in polymer backbones except for Tröger's base linkage. Rigid ladder polymers may be synthesized by palladium or nickel-catalyzed annulation (Yan Xia, et al. “Efficient synthesis of rigid ladder polymers,” U.S. Pat. No. 9,708,443, Jul. 18, 2017).

There are a wide variety of rigid-rod and ladder polymers that can be used as a thermally stable polymer in the disclosed polymer composite separators. These thermally stable polymers have a high thermo-oxidative degradation temperature, typically having a degradation temperature higher than 250° C., more typically higher than 300° C., further typically higher than 350° C., some even higher than 400° C., or higher than 450° C.). Several non-limiting examples are given below:

The thermally stable polymers within the contemplation of the present disclosure include homopolymers having the repeating structural unit:

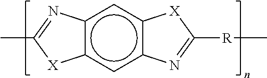

where X is the same or different and is sulfur, oxygen or —NR¹; R is

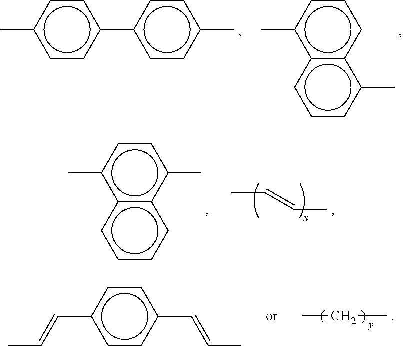

when X is the same or different and is sulfur or oxygen, however, R is nil,

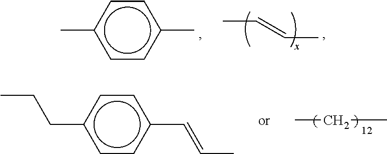

when X is —NR¹; R¹ is hydrogen or hydrocarbyl; x is 1 or 2; y is an integer of 8 to 11; z is 1 or 2; and n is an integer of 2 to 2,000.

Another class of rigid rod and ladder polymers within the contemplation of the present disclosure is characterized by the repeating structural unit

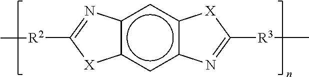

where X, R¹ and n have the meanings given above; R² is

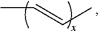

when R³ is

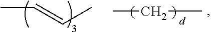

however, R² is

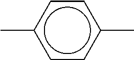

when R³ is

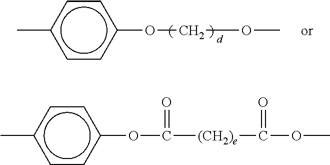

wherein d integer of 1 to 5; e is an integer of I to 18; and f is an integer of to 18.

Yet another class of rigid rod and ladder polymers encompassed by the present disclosure is a polymer having the repeating structural unit

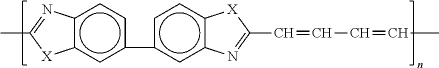

where X and n have the meanings given above.

The present disclosure is not limited to homopolymers of the repeating structural units recited hereinabove. Copolymers of at least two repeating structural units within the scope of one or more of the above generic repeating structural units are within the contemplation of the present disclosure.

Production methods for the aforementioned rigid-rod and ladder polymers are well-known in the art. However, it has not been known that these polymers, in combination with a lithium salt or particles of an inorganic solid electrolyte, can be used as a polymer composite separator that has desired properties such as a high lithium-ion conductivity and the ability to stop the lithium metal dendrite in a lithium metal battery.

In certain embodiments, the inorganic material comprises particles of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof. Alternatively or additionally, the inorganic material particles may comprise a material selected from a transition metal oxide, aluminum oxide, silicon dioxide, transition metal sulfide, transition metal selenide, alkylated ceramic particles, metal phosphate, metal carbonate, or a combination thereof.

Preferably, the thermally stable polymer forms a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, polymethyl acrylate, polymethyl methacrylate, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof. Mixing, co-polymerizing or semi-IPN formation methods are well-known in the art. For instance, one can simply dissolve the two polymers and/or their monomers in a common solvent, following by solvent removal to form a polymer blend. Chemical reaction between chains can be activated while these polymers/monomers are in a solution state or a solid mixed state.

In certain embodiments, the anode in the lithium secondary battery has an amount of lithium or lithium alloy as an anode active material supported by an anode current collector. In certain other embodiments, initially the anode has no lithium or lithium alloy as an anode active material supported by an anode current collector when the battery is made and prior to a charge or discharge operation of the battery. This latter configuration is referred to as an anode-less lithium battery. The current collector may be a Cu foil, a layer of Ni foam, a porous layer of nano-filaments, such as graphene sheets, carbon nanofibers, carbon nano-tubes, etc. forming a 3D interconnected network of electron-conducting pathways.

Preferably, this polymer composite separator layer is different in composition than the working electrolyte used in the lithium battery and the polymer composite layer maintains as a discrete layer (not to be dissolved in the working electrolyte).

We have discovered that this composite ceramic layer provides several unexpected benefits: (a) the formation and penetration of dendrite can be essentially eliminated; (b) uniform deposition of lithium back to the anode side is readily achieved during battery charging; (c) the layer ensures smooth and uninterrupted transport of lithium ions from/to the anode current collector surface (or the lithium film deposited thereon during the battery operations) and through the interface between the current collector (or the lithium film deposited thereon) and the polymer composite separator layer with minimal interfacial resistance; and (d) cycle stability can be significantly improved and cycle life increased. No additional protective layer for the lithium metal anode is required. The separator itself also plays the role as an anode protective layer.

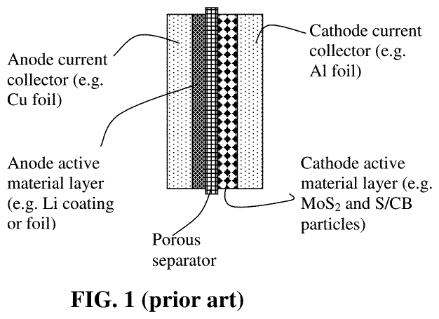

In a conventional lithium metal cell, as illustrated in FIG. 1, the anode active material (lithium) is deposited in a thin film form or a thin foil form directly onto an anode current collector (e.g., a Cu foil) before this anode and a cathode are combined to form a cell. The battery is a lithium metal battery, lithium sulfur battery, lithium-selenium battery, etc. As previously discussed in the Background section, these lithium secondary batteries have the dendrite-induced internal shorting and “dead lithium” issues at the anode.

We have solved these challenging issues that have troubled battery designers and electrochemists alike for more than 30 years by developing and implementing a new polymer composite separator disposed between the anode (an anode current collector or an anode active material layer) and a cathode active material layer. This polymer composite separator layer has a lithium-ion conductivity no less than 10⁻⁸ S/cm at room temperature (preferably and more typically from 1×10⁻⁵ S/cm to 5 x10⁻² S/cm).

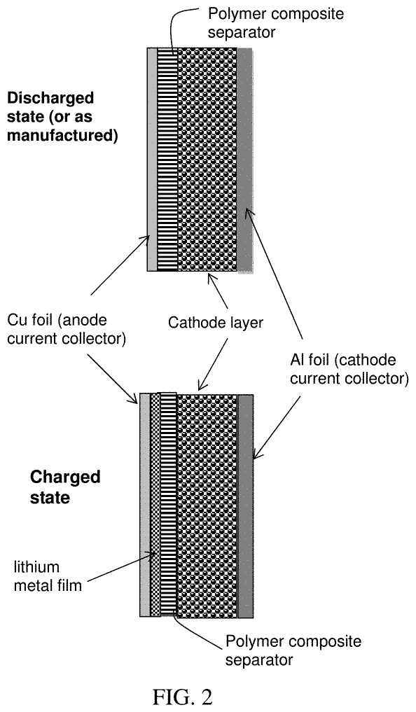

As schematically shown in FIG. 2, one embodiment of the present disclosure is a lithium metal battery cell containing an anode current collector (e.g., Cu foil), an anode-protecting layer, a polymer composite-based separator, and a cathode active material layer. The cathode active material layer is composed of particles of a cathode active material, a conductive additive (not shown) and a resin binder (not shown). A cathode current collector (e.g., Al foil) supporting the cathode active layer is also shown in FIG. 2.

It may be noted that FIG. 2 shows a lithium battery that initially does not contain a lithium foil or lithium coating at the anode (only an anode current collector, such as a Cu foil or a graphene/CNT mat) when the battery is made. The needed lithium to be bounced back and forth between the anode and the cathode is initially stored in the cathode active material (e.g., lithium vanadium oxide LiₓV₂O₅, instead of vanadium oxide, V₂O₅; or lithium polysulfide, instead of sulfur). During the first charging procedure of the lithium battery (e.g., as part of the electrochemical formation process), lithium comes out of the cathode active material, passes through the elastic composite separator and deposits on the anode current collector. The presence of the presently invented polymer composite separator (in good contact with the current collector) enables the uniform deposition of lithium ions on the anode current collector surface. Such a battery configuration avoids the need to have a layer of lithium foil or coating being present during battery fabrication. Bare lithium metal is highly sensitive to air moisture and oxygen and, thus, is more challenging to handle in a real battery manufacturing environment. This strategy of pre-storing lithium in the lithiated (lithium-containing) cathode active materials, such as LiₓV₂O₅ and Li₂Sₓ, makes all the materials safe to handle in a real manufacturing environment. Cathode active materials, such as LiₓV₂O₅ and Li₂Sₓ, are typically not air-sensitive.

As the charging procedure continues, more lithium ions get to deposit onto the anode current collector, forming a lithium metal film or coating. During the subsequent discharge procedure, this lithium film or coating layer decreases in thickness due to dissolution of lithium into the electrolyte to become lithium ions, creating a gap between the current collector and the protective layer if the separator layer were not elastic. Such a gap would make the re-deposition of lithium ions back to the anode impossible during a subsequent recharge procedure. We have observed that a selected polymer composite separator layer is capable of expanding or shrinking congruently or conformably with the anode layer. This capability helps to maintain a good contact between the current collector (or the lithium film subsequently or initially deposited on the current collector surface) and the protective layer, enabling the re-deposition of lithium ions without interruption.

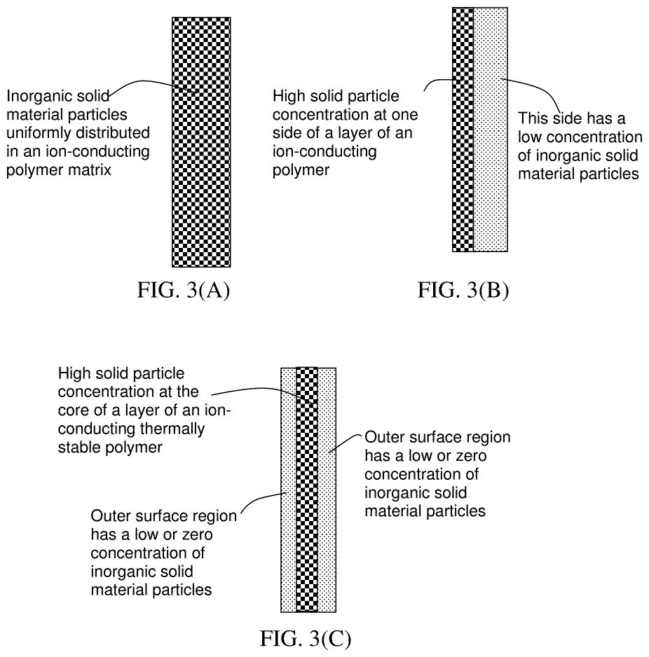

In certain embodiments, inorganic material particles are non-uniformly distributed in the thermally stable polymer matrix in such a manner that a concentration of the inorganic material particles in one region of the polymer matrix is greater than a concentration of the inorganic material particles in another region. For instance, FIG. 3(A) schematically shows a polymer composite separator layer wherein inorganic solid material particles are uniformly dispersed in a matrix of an elastic polymer according to some embodiments of the present disclosure.

According to some other embodiments of the present disclosure, FIG. 3(B) schematically shows a polymer composite separator layer wherein inorganic solid electrolyte particles are preferentially dispersed near one surface (e.g., facing the anode side) of an elastic composite separator layer; the opposing surface has a lower or zero concentration of the inorganic solid electrolyte particles. This latter structure has the advantages that the high-concentration portion, being strong and rigid, provides a lithium dendrite-stopping capability while other portion of the layer remains highly elastic to maintain good contacts with neighboring layers (e.g., cathode active material layer containing a solid electrolyte on one side and lithium metal on the other) for reduced interfacial impedance.

FIG. 3(C) schematically shows a polymer composite separator layer wherein the inorganic solid electrolyte particles are disposed at the core of a polymer composite separator layer and the outer regions have a lower or zero concentration of the inorganic solid electrolyte particles, according to some embodiments of the present disclosure. The softer outer regions are more conducive to a good contact between the separator and the anode or the cathode layer, thereby reducing the interfacial impedance.

Preferably, the inorganic solid electrolyte material is in a fine powder form having a particle size preferably from 10 nm to 30 μm (more preferably from 50 nm to 1 μm). The inorganic solid electrolyte material may be selected from an oxide type (e.g., perovskite-type), sulfide type, hydride type, halide type, borate type, phosphate type, lithium phosphorus oxynitride (LiPON), Garnet-type, lithium superionic conductor (LISICON), sodium superionic conductor (NASICON), or a combination thereof.

The inorganic solid electrolytes that can be incorporated into a polymer matrix as an ion-conducting additive to make a separator include, but are not limited to, perovskite-type, NASICON-type, garnet-type and sulfide-type materials. A representative and well-known perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺on contact with lithium metal. However, we have found that this material, when dispersed in an elastic polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a brand series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The highest reported conductivity in this type of material is 6.9×10⁻⁴ S/cm, which was achieved by doping the Li₂S—SiS₂ system with Li₃PO₄. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer.

These solid electrolyte particles dispersed in a thermally stable polymer can help stop the penetration of lithium dendrites (if present) and enhance the lithium-ion conductivity of certain polymers having an intrinsically low ion conductivity.

Preferably and typically, the thermally stable polymer has a lithium-ion conductivity no less than 10−⁵ S/cm, more preferably no less than 10⁻⁴ S/cm, further preferably no less than 10⁻³ S/cm, and most preferably no less than 10⁻² S/cm. The composite separator is a polymer matrix composite containing from 1% to 99% (preferably 30% to 95% and most preferably 60% to 90%) by weight of lithium ion-conducting solid electrolyte particles dispersed in or bonded by a polymer matrix material.

Typically, a thermally stable polymer is originally in a monomer or oligomer state that can be polymerized into a linear or branched polymer or cured to form a cross-linked polymer. Prior to curing, these polymers or oligomers are soluble in an organic solvent to form a polymer solution. An ion-conducting or electron-conducting additive may be added to this solution to form a suspension. This solution or suspension can then be formed into a thin layer of polymer precursor on a surface of an anode current collector or a solid substrate surface. The polymer precursor (monomer and initiator or oligomer and a crosslinker, etc.) is then polymerized and/or cured to form a cross-linked polymer. This thin layer of polymer may be tentatively deposited on a solid substrate (e.g., surface of a polymer or glass), dried, and separated from the substrate to become a free-standing polymer layer. This free-standing layer is then laid on a lithium foil/coating or implemented between an anode layer (e.g., a Si-based anode active material layer or a lithium film/coating) and a cathode layer. Polymer layer formation can be accomplished by using one of several procedures well-known in the art; e.g., spraying, spray-painting, printing, coating, extrusion-based film-forming, casting, etc.

Preferably, the lithium salt occupies 0.1%-30% by weight and the crosslinking agent and/or initiator occupies 0.1-50% by weight of the reactive polymer precursor. It may be advantageous for these materials to form a lightly cross-linked network of polymer chains. In other words, the network polymer or cross-linked polymer preferably has a relatively low degree of cross-linking or low cross-link density to impart a high elastic deformation.

The polymer may contain a simultaneous interpenetrating network (SIN) polymer, wherein two cross-linking chains intertwine with each other, or a semi-interpenetrating network polymer (semi-IPN), which contains a cross-linked polymer and a linear polymer.

The thermally stable polymer can be mixed with a broad array of elastomers, lithium ion-conducting materials, and/or strengthening materials (e.g., glass fibers, ceramic fibers or particles, polymer fibers, such as aramid fibers).

A broad array of elastomers can be mixed with a thermally stable polymer to form a blend, co-polymer, or interpenetrating network that serves to bond the inorganic solid particles together as a separator layer. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually consists of two types of domains, soft domains and hard ones. Entangled linear backbone chains consisting of poly (tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

In some embodiments, a thermally stable polymer can form a polymer matrix composite containing a lithium ion-conducting additive dispersed in the high-elasticity polymer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4.

In some embodiments, the thermally stable polymer can be mixed with a lithium ion-conducting additive, which contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

The presently invented lithium secondary batteries can contain a wide variety of cathode active materials. The cathode active material layer may contain a cathode active material selected from an inorganic material, an organic material, a polymeric material, or a combination thereof.

The inorganic cathode active material may be selected from a metal oxide, metal phosphate, metal silicide, metal selenide, transition metal sulfide, sulfur, lithium polysulfide, selenium, lithium selenide, or a combination thereof.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V, Ti, Al, B, Sn, or Bi; and x+y≤b 1.

Examples of the lithium transition metal oxide- or lithium mixed transition metal oxide-based positive active materials include: Li (M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, where M is a metal, (e.g. Li(Co_{X}Ni_{1-X})O₂ and Li(Co_{X}Fe_{1-X})O₂), Li_{1-w}(Mn_{X}Ni_{Y}Co_{Z})O₂, (e.g. Li(Co_{X}Mn_{Y}Ni_{(1-X-Y)})O₂, Li(Mn_{1/3}Ni_{1/3}Co_{1/3})O₂, Li(Mn_{1/3}Ni_{1/3}Co_{1/3-X}Mg_{X})O₂, Li(Mn_{0.4}Ni_{0.4}Co_{0.2})O₂, Li(Mn_{0.1}Ni_{0.1}Co_{0.8})O₂), Li_{1-W}(Mn_{X}Ni_{X}Co_{1-2X})O₂, Li_{1-W}Mn_{X}Ni_{Y}CoAl_{W})O₂, Li_{1-W} (Ni_{X}Co_{Y}Al_{Z})O₂, where W=0-1, (e.g., Li(Ni_{0.8}Co_{0.15}Al_{0.05})O₂), Li_{1-W}(Ni_{X}Co_{Y}M_{Z})O₂, where M is a metal, Li_{1-W}(Ni_{X}Mn_{Y}M_{Z})O₂, where M is a metal, Li(Ni_{X}Mn_{Y}Cr_{2-X})O₄, LiM′M″₂O₄, where M′ and M″ are different metals (e.g., LiMn_{2-Y-Z} Ni_{Y}O₄, LiMn_{2-Y-Z} Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-z} F_{z}, Li₂MnO₃) Li_{X}V_{Y}O_{Z}, e.g. LiV₃O₈, LiV₂O₅, and LiV₆O₁₃. This list includes the well-known lithium nickel cobalt manganese oxides (NCM) and lithium nickel cobalt manganese aluminum oxides (NCM), among others.

The metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In certain desired embodiments, the inorganic material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%. In some preferred embodiments, prelithiated anode comprises Si that is prelithiated to approximately 60-100% and the cathode comprises a cathode active material that is initially lithium-free.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The organic material or polymeric material may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-enzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from Poly[methanetetryl-tetra(thiomethylene)] (PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

The organic material may contain a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The working electrolyte used in the lithium battery may be a liquid electrolyte, polymer gel electrolyte, solid-state electrolyte (including solid polymer electrolyte, inorganic electrolyte, and composite electrolyte), quasi-solid electrolyte, ionic liquid electrolyte. The liquid electrolyte or polymer gel electrolyte typically comprises a lithium salt dissolved in an organic solvent or ionic liquid solvent. There is no particular restriction on the types of lithium salt or solvent that can be used in practicing the present disclosures. Some particularly useful lithium salts are lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

There are a wide variety of processes that can be used to produce layers of polymer composite separators. These include coating, casting, painting, spraying (e.g., ultrasonic spraying), spray coating, printing (screen printing, 3D printing, etc.), tape casting, etc.

In certain embodiments, the process for manufacturing polymer composite separators may comprise (A) dispersing a lithium salt and/or particles of an inorganic solid (e.g., solid electrolyte particles) in a liquid reactive mass (e.g., monomers or oligomers and an initiator and/or crosslinker) of a polymer precursor (precursor to a thermally stable polymer) to form a slurry; (B) dispensing and depositing a layer of the liquid reactive mass onto a solid substrate surface; and (C) polymerizing and/or crosslinking the reactive mass to form a layer of polymer composite separator.

The solid substrate may be an anode current collector, an anode active material layer, or a cathode active material layer. In other words, this polymer composite separator can be directly deposited onto a layer of anode active material, an anode current collector, or a layer of cathode active material. This is achievable because curing of the polymer does not require a high temperature; curing temperature typically lower than 300° C. or even lower than 100° C. This is in stark contrast to the typically 900-1,200° C. required of sintering an inorganic solid electrolyte to form a ceramic separator. In addition, the presently disclosed separator is at least as good as a ceramic separator in terms of reducing interfacial impedance and stopping dendrite penetration.

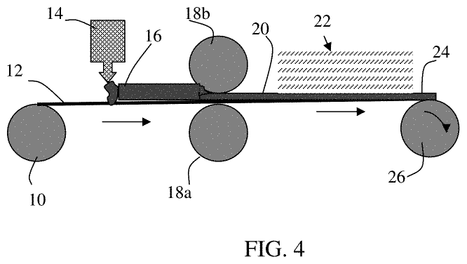

Preferably, the process is a roll-to-roll process wherein step (B) comprises (i) continuously feeding a layer of the solid substrate (e.g. flexible metal film, plastic film, etc.) from a feeder roller to a dispensing zone where the reactive mass is dispensed and deposited onto the solid substrate to form a continuous layer of the reactive mass; (ii) moving the layer of the reactive mass into a reacting zone where the reactive mass is exposed to heat, ultraviolet (UV) light, or high-energy radiation (e.g., electron beam or y radiation) to polymerize and/or cure the reactive mass to form a continuous layer of polymer composite; and (iii) collecting the polymer composite on a winding roller. This process is conducted in a reel-to-reel manner. In certain embodiments, as illustrated in FIG. 4, the roll-to-roll process may begin with continuously feeding a solid substrate layer 12 (e.g., PET film) from a feeder roller 10. A dispensing device 14 is operated to dispense and deposit a reactive mass 16 (e.g., slurry) onto the solid substrate layer 12, which is driven toward a pair of rollers (18a, 18b). These rollers are an example of a provision to regulate or control the thickness of the reactive mass 20. The reactive mass 20, supported on the solid substrate, is driven to move through a reacting zone 22 which is provided with a curing means (heat, UV, high energy radiation, etc.). The partially or fully cured polymer composite 24 is collected on a winding roller 26. One may unwind the roll at a later stage.

The process may further comprise cutting and trimming the layer of polymer composite into one or multiple pieces of polymer composite separators.

The process may further comprise combining an anode, the polymer composite separator, an electrolyte, and a cathode electrode to form a lithium battery.

The lithium battery may be a lithium metal battery, lithium-ion battery, lithium-sulfur battery, lithium-selenium battery, lithium-air battery, etc. The cathode active material in the lithium-sulfur battery may comprise sulfur or lithium polysulfide.

### EXAMPLE 1: Preparation of Solid Electrolyte Powder, Lithium Nitride Phosphate Compound (LiPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form.

### EXAMPLE 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting solid electrolyte material was then subjected to grinding in a mortar to form a powder sample to be later added as an inorganic solid electrolyte particles dispersed in an intended elastic polymer matrix (examples of thermally stable polymers are given below).

### EXAMPLE 3: Preparation of Garnet-Type Solid Electrolyte Powder

The synthesis of the c-Li_{6.25}Al_{0.25}La₃Zr₂O₁₂ was based on a modified sol—gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was dispersed in several ion-conducting polymers discussed in below examples.

### EXAMPLE 4: Preparation of Sodium Superionic Conductor (NASICON) Type Solid Electrolyte Powder

The Na_{3.1}Zr_{1.95}M_{0.05}Si₂PO₁₂ (M=Mg, Ca, Sr, Ba) mateials were synthesized by doping with alkaline earth ions at octahedral 6-coordination Zr sites. The procedure employed includes two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### EXAMPLE 5: Preparation of Polybenzoxazole (PBO) Composite Separators

Polybenzoxazole (PBO) layers were prepared via casting and thermal conversion from its precursor, methoxy-containing polyaramide (MeO-PA) with a lithium salt and/or a plurality of an inorganic material dispersed therein. Specifically, monomers of 4, 4′-diamino-3,3′-dimethoxydiphenyl (DMOBPA), and isophthaloyl dichloride (IPC) were selected to synthesize PBO precursors, methoxy-containing polyaramide (MeO-PA) solution. This MeO-PA solution for casting was prepared by polycondensation of DMOBPA and IPC in DMAc solution in the presence of pyridine and LiCl at −5° C. for 2 hr, yielding a 20 wt % pale yellow transparent MeO-PA solution. The inherent viscosity of the resultant MeO-PA solution was 1.20 dL/g measured at a concentration of 0.50 g/dl at 25° C. This MeO-PA solution was diluted to a concentration of 15 wt % by DMAc and added with a lithium salt and/or a plurality of particles of an inorganic material prior to the procedure of casting.

The as-synthesized MeO-PA was cast onto a glass surface to form thin films (15-90 μm) under a shearing condition. The cast film was dried in a vacuum oven at 100° C. for 4 hr to remove the residual solvent. Then, the resulting film having a thickness of approximately 28-100 μm was treated at 200° C-350° C. under N₂ atmosphere in three steps and annealed for about 2 hr at each step. This heat treatment serves to thermally convert MeO-PA into PBO films. The chemical reactions involved may be illustrated below:

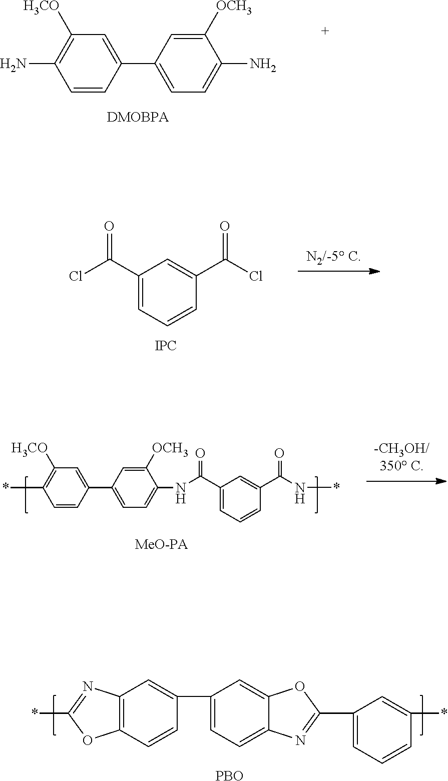

The lithium salts used were lithium hexafluorophosphate, LiPF₆, and lithium borofluoride, LiBF₄, respectively. LGPS-type solid electrolyte and LLZO were used as an inorganic material filler. The lithium ion conductivity values of PBO can be enhanced by 4 orders of magnitude by adding a desired amount of a lithium salt and/or a solid inorganic electrolyte.

### EXAMPLE 6: Polyimide Based Polymer Composite Separators

The chemicals used in this project include methanol, tetrahydrofuran (THF), 3,3′,4,4′-Benzophenonetetracarboxylic dianhydride (BTDA), 5-norbornene-2,3-dicarboxylic anhydride (NA), 4,4′-Methylene dianiline (MDA), and 4,4′-Methylenebis-(5-isopropyl-2-methylaniline) (CDA). A representative synthesis procedure for a PMR resin from 4,4′-methylenebis-(5-isopropyl-2-methylaniline), as a first step to produce PI, is briefly described below: In a dry, N₂-filled glove box, BTDA (0.7825 g, 2.43 mmol) and NA (0.3995 g, 2.44 mmol) were added to a 25 mL round-bottomed flask. The flask was removed from the glove box and MeOH (8.5 mL) was added. The mixture was stirred and refluxed for 2 h, during which time the anhydride powders dissolved and the solution turned pale yellow. The solution was then left to cool to ambient temperature. Subsequently, CDA (1.1659 g, 3.76 mmol) was added to the solution. The bisaniline got rapidly dissolved and the solution transitioned to a darker yellow/amber color. The solution was left to stir overnight and the solvent was then evaporated to yield 2.24 g of a bright yellow amic acid powder. In a procedure, a desired amount (10% by weight based on the final PI weight) of a lithium salt (bis-trifluoromethyl sulfonylimide lithium, LiN(CF₃SO₂)₂) and 1.8 g of the powder was heated in an oven at 200° C. for 2 h in air followed by 30 min at 230° C. for imidization.

The second step entailed cross-linking of the PMR resin, which was carried out by following the following procedure: A 0.5-inch diameter cylindrical compression mold was charged with 0.3502 g of imide powder. A piston was inserted into the cylinder and the mold was placed into a 1-ton heated press to cure. With a minimal pressure applied (just enough to contact the mold assembly to allow for heating from the top and bottom), the temperature was ramped from ambient temperature to 280° C. at 5.5° C. min⁻¹. A pressure of 184 psi was applied while the temperature was further ramped to 315° C. at 0.5° C. min⁻¹. The temperature and pressure were held for 90 min and then the mold was allowed to cool to ambient temperature. A solid, dark brown-colored disc was recovered. The disc with a thickness of 22 μm was used as a separator in a lithium cell.

### EXAMPLE 7: Preparation of Polyimide (PI) Composite layers

As another example, the synthesis of polyimide (PI) involved poly(amic acid) (PAA, formed from pyromellitic dianhydride (PMDA) and oxydianiline (ODA). Prior to use, both chemicals were dried in a vacuum oven at room temperature. Then, 4 g of the monomer ODA was dissolved into 21 g of DMF solution (99.8 wt %). This solution was stored at 5° C. before use. PMDA (4.4 g) was added, and the mixture was stirred for 30 min using a magnetic bar.

Subsequently, the clear and viscous polymer solution was separated into four samples. Triethyl amine catalyst (TEA) with 0, 1, 3, and 5 wt % was then added into each sample to control the molecular weight. Stirring was maintained by a mechanical stirrer until the entire quantity of TEA was added. The as-synthesized PAA was kept at −5° C. to maintain properties essential to further processing.

Solvents utilized in the poly(amic acid) synthesis are an important consideration. Common dipolar aprotic amide solvents utilized are DMF, DMAc, NMP and TMU. DMAc was a preferred solvent utilized in the present study. The intermediate poly(amic acid) and PAA-inorganic particle precursor composite were converted to the final polyimide by the thermal imidization route. The inorganic fillers selected were nano particles of TiO₂, Al₂O₃, SiO₂, and LLZO, separately. These particles were then mixed with the PAA solution, well stirred, and cast onto a glass surface to form reactive layers. Films were first cast on a glass substrate and then allowed to proceed through a thermal cycle with temperatures ranging from 100° C. to 350° C. The procedure entailed heating the poly(amic acid) mixture to 100° C. and holding for one hour, heating from 100° C. to 200° C. and holding for one hour, heating from 200° C. to 300° C. and holding for one hour and slow cooling to room temperature from 300° C.

A separator layer was then laminated between a Cu foil and a cathode active layer for use in an anode-less lithium battery (initially the cell being lithium-free) containing a NCM-532 cathode. Another protective layer was disposed between a Cu foil-supported lithium metal foil and a separator in a lithium-sulfur cell containing a graphene/S composite cathode.

### EXAMPLE 8: Composite Separator Layer Based on Phenolic Resin

Phenol formaldehyde resins (PF) are synthetic polymers obtained by the reaction of phenol or substituted phenol with formaldehyde. The PF resin, alone or with up to 90% by weight inorganic material particles (fine particles of NASICON-type solid electrolyte), was made into 20-μm thick film and cured under identical curing conditions: a steady isothermal cure temperature at 100° C. for 2 hours and then increased from 100 to 170° C. and maintained at 170° C. to complete the curing reaction. Two types of battery cells were studied in this example: a lithium/NCM-811 cell (initially the cell being lithium-free at the anode side) and a lithium/NCA cathode (initially lithium-free at the anode).

### EXAMPLE 9: Preparation of Polybenzimidazole (PBI) Composite Separators

PBI was prepared by step-growth polymerization from 3,3′,4,4′-tetraaminobiphenyl and diphenyl isophthalate (an ester of isophthalic acid and phenol). The PBI used in the present study was obtained from PBI Performance Products in a PBI solution form, which contains 0.7 dl/g PBI polymer dissolved in dimethylacetamide (DMAc). A lithium salt (e.g., 10% lithium borofluoride (LiBF₄) or lithium trifluoro-metasulfonate (LiCF₃SO₃)) was then dissolved/dispersed in the DMAc solution. On a separate basis, particles of inorganic solid electrolyte (LGPS-type solid electrolyte) were added into the DMAc solution. The lithium salt-PBI and inorganic-PBI composite films were cast onto the surface of a glass substrate and cured.

Three types of battery cells were studied in this example: a lithium/NCM-811 cell (initially the cell being lithium-free), a Si/NCM-811 Li-ion cell, and a lithium-sulfur cell. Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the cells containing a polymer composite separator layer perform very well in terms of cycling stability and the energy storage capacity and yet these cells are flame resistant and relatively safe.

### EXAMPLE 10: Ladder Polymer-Solid Electrolyte Composite Separators

As an example of a ladder polymer, a Si-containing ladder polymer was synthesized. This began with the synthesis of a prepolymer. To a 300 ml volume three necked flask substituted with nitrogen, were charged 50 g of methyl vinyl bis-(dimethylamino)silane and 80 ml of n-hexane. Then, 11 mmol of n-butyl in an n-hexane solution were added to carry out polymerization under stirring. After carrying out the polymerizing reaction at a temperature of 40° C. for 3 hours, the reaction solution was dropped in methanol to precipitate the polymer. The polymer was washed and filtered repeatedly for 3-4 times using methanol and then dried under vacuum. The polymer was obtained in an amount of 23.3 g.

In a 500 ml volume three necked flask substituted with nitrogen, 20 g of the prepolymer obtained in the step above were charged and dissolved in 300 ml of toluene. After dissolving, 30 ml of glacial acetic acid were added dropwise to react under a nitrogen stream while stirring at room temperature. After one hour reaction, 1.5 g of dimethyl diacetoxysilane were added and the stirring was continued for 15 min and then 2.5 ml of water were added dropwise to react for 10 min and the reaction was continued for one hour while stirring at room temperature. After the reaction was completed, the resultant solution was transferred to a separating funnel and 200 ml of diethyl ether were added. Then, water was added for washing through shaking to separate the aqueous layer. After repeating the water washing procedure for three times, the organic layer was separated, incorporated with anhydrous potassium carbonate and dried over one night. After filtering out potassium carbonate, the solution was transferred to a flask and heated in a warm water bath to distill off the ether. Nanoparticles of SiO₂ were then added into the solution to form a suspension. The suspension was cast onto a glass surface and heated to 75-80° C. to distill off toluene under a reduced pressure. In several samples, a garnet-type solid electrolyte (Li₇La₃Zr₂O₁₂ (LLZO) powder) was added into the reactive slurry to form polymer composite separator layers.

Molecular weight measurements indicate that the weight average molecular weight was 1.7×10⁴ and a step ladder polymer comprising 15 segments of the prepolymer hydrolytic condensates was formed. Further, the presence of the silanol group (Si—OH) was observed as the result of the infrared absorption spectroscopy.

An anode, a. composite separator, and a cathode layer were then stacked together and encased by a protective housing to make a battery cell.

For electrochemical testing, the working electrodes (cathode layers) were prepared by mixing 85 wt. % LiV₂O₅ or 88% of graphene-embraced LiV₂O₅ particles, 5-8 wt. % CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were conducted on cells that are initially lithium metal-free and cells that contain a lithium foil. In the former cells (anode-less cells), a Cu foil coated with a polymer composite separator, and a cathode layer were combined to form a cell, which was injected with an electrolyte solution containing 1 M LiPF₆ dissolved in a mixture of ethylene carbonate (EC) and diethyl carbonate (DEC) (EC-DEC, 1:1 v/v). The cell assembly was performed in an argon-filled glove-box. For comparison purposes, cells with the conventional Celgard 2400 membrane (porous PE-PP film) as a separator. The CV measurements were carried out using a CH-6 electrochemical workstation at a scanning rate of 1-100 mV/s. The electrochemical performance of the cell featuring the polymer composite separator and that containing a conventional separator were evaluated by galvanostatic charge/discharge cycling at a current density of 50 mA/g using an Arbin electrochemical workstation.

The specific intercalation capacity curves of two lithium cells each having a cathode containing LiV₂O₅ particles (one cell having a thermally stable polymer-based separator and the other a conventional separator) were obtained and compared. As the number of cycles increases, the specific capacity of the conventional cells drops at a very fast rate. In contrast, the presently invented cross-linked polymer composite-based protection layer provides the battery cell with a significantly more stable and high specific capacity for a large number of cycles. These data have demonstrated the surprising and superior performance of the presently invented high-temperature ladder polymer composite separator approach.

### EXAMPLE 11: Polybenzobisimidazole (PBBI) Rigid-Rod/Ladder Polymer-Solid Electrolyte Composite Separators

In a representative procedure, 1,2,4,5-Tetraminobenzene tetrahydrochloride (TABH) (4.0 g, 14.18 mmol) was dissolved in 77% polyphosphoric acid (PPA) (12 g). The 77% PPA was prepared by conibining polyphosphoric acid and 85% phosphoric acid, The thus formed solution of TABH in PPA was placed in a glass reactor fitted with a mechanical stirrer, two gas ports and a side arm, The reaction vessel was purged with nitrogen for 20 minutes and thereupon maintained at a temperature of 80° C. under vacuum for 24 hours. After this treatment. complete dehydrochlorination occurred and the reaction mixture was cooled to 50° C. under a nitrogen atmosphere.

Subsequently, oxalic acid (1.277 g, 14.18 mmol) and phosphorus pentoxide (P₂O₅) (8 g), the P₂O₅ to compensate for the calculated water of condensation, was added to the dehydrochlorinated product. Nanoparticles of Ti(O₂ and Al₂O₃ were separately added into the reactive mass. The reaction temperature was raised to 121° C. and held at this temperature for 10 hours. The reaction temperature was thereupon raised to 140° C. and finally to a range of 180° to 200° C. The reaction was allowed to proceed in this elevated temperature range of 180° to 200° C. for 36 hours, The resultant product, a polymerization dope in PPA. was cast and roll-pressed to a desired thickness (25-30 μm), and cooled to room temperature. The product was thereupon purified by extraction of the PPA with water for three days, Both surfaces of the resultant composite sheets were then coated with poly(ethylene glycol) diacrylate.

### EXAMPLE 12: Preparation of Poly(benzobisimidazole vinylene) (PBIV)-Based Composite Separators

TABH (5.2 g 18.3 mmol) was dehydrochlorinated in deacrated 77% (PPA) (16.5 g) in accordance with the procedure utilized in Example 11. Upon complete dehydrochlorination, and under the conditions presented in Example 1, fumaric acid (2.125 g, 18.3 mmol) and P₂O₅ (12.2 g) were added. Nanoparticles of SiO₂) were added into the reactive mass. The reactive composite mass was cast over a stainless steel sheet surface and compressed into a sheet desired thickness. The temperature was gradually raised to 120° C. over a period of six hours and then to 160° C. and finally to 180° C. This polymerization mixture, which became yellowish-brown in color, was allowed to proceed at 180° C. for 24 hours. The polymeric dope mixture wa.s then purified by extraction in water for three days, producing a porous composite structure. The porous sheet was impregnated with poly(vinylidene fluoride)-hexafluoropropylene (PVDF-HFP) via dip coating with a polymer solution of PVDF-HFP in acetone.

In conclusion, the thermally stable polymer composite-based separator strategy is surprisingly effective in alleviating the problems of lithium metal dendrite formation and lithium metal-electrolyte reactions that otherwise lead to rapid capacity decay and potentially internal shorting and explosion of the lithium secondary batteries. The thermally stable polymer, when in combination with a lithium salt and/or a plurality of particles of an inorganic solid electrolyte, also exhibit a good lithium-ion conductivity.

We claim:

1. A lithium secondary battery comprising a cathode, an anode, and a thermally stable polymer composite separator disposed between said cathode and said anode, wherein said composite separator comprises (i) a thermally stable polymer; (ii) from 0.1% to 30% by weight of a lithium salt dispersed in the thermally stable polymer; and (iii) from 30% to 99% by weight of particles of an inorganic material, wherein said composite separator has a thickness from 50 nm to 100 μm and a lithium-ion conductivity from 10⁻⁸ S/cm to 5×10⁻² S/cm at room temperature and wherein said thermally stable polymer is selected from the group consisting of polyimide, poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof.

2. A lithium secondary battery comprising a cathode, an anode, and a thermally stable polymer composite separator disposed between said cathode and said anode, wherein said composite separator comprises (i) a thermally stable polymer and (ii) from 30% to 99% by weight of particles of an inorganic solid electrolyte material, wherein said polymer composite separator has a thickness from 50 nm to 100 μm and a lithium-ion conductivity from 10⁻⁸ S/cm to 5×10⁻² S/cm at room temperature and wherein said thermally stable polymer is selected from the group consisting of polyimide, poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1,3,4-oxadiazoles), poly(1,2,4-oxa-diazoles), poly(1,2,4- and 1,2,5-oxadiazole-N-oxides), polythiadiazoles, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof and wherein said inorganic solid electrolyte material is selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

3. The lithium secondary battery of claim 1, wherein said inorganic material comprises particles of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASION) type, or a combination thereof.

4. The lithium secondary battery of claim 1, wherein said inorganic material particles comprise a material selected from a transition metal oxide, aluminum oxide, silicon dioxide, transition metal sulfide, transition metal selenide, alkylated ceramic particles, metal phosphate, metal carbonate, or a combination thereof.

5. The lithium secondary battery of claim 1, wherein the thermally stable polymer forms a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polymethyl acrylate, polymethyl methacrylate, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

6. The lithium secondary battery of claim 2, wherein the thermally stable polymer forms a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly bis-methoxy ethoxyethoxide-phosphazene, polyvinyl chloride, polydimethylsiloxane, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polymethyl methacrylate, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

7. The lithium secondary battery of claim 1, wherein said lithium salt is selected from lithium perchlorate (LiClo₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4, or a combination thereof.

8. The lithium secondary battery of claim 1, wherein the battery is a lithium metal battery and the anode has an anode current collector but initially the anode has no lithium or lithium alloy as an anode active material supported by said anode current collector when the battery is made and prior to a charge or discharge operation of the battery.

9. The lithium secondary battery of claim 1, wherein the battery is a lithium metal battery and the anode has an anode current collector and an amount of lithium or lithium alloy as an anode active material supported by said anode current collector.

10. The lithium secondary battery of claim 1, wherein the battery is a lithium-ion battery and the anode has an anode current collector and a layer of an anode active material supported by said anode current collector, wherein the anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

11. The lithium secondary battery of claim 1, wherein said battery further comprises a working electrolyte in ionic contact with an anode active material and/or a cathode active material wherein said working electrolyte is selected from an organic liquid electrolyte, ionic liquid electrolyte, polymer gel electrolyte, polymer solid electrolyte, solid-state inorganic electrolyte, quasi-solid electrolyte having a lithium salt dissolved in an organic or ionic liquid with a lithium salt concentration higher than 2.0 M, or a combination thereof.

12. The lithium secondary battery of claim 1, wherein said cathode comprises a cathode active material selected from an inorganic material, an organic material, a polymeric material, or a combination thereof.

13. The lithium secondary battery of claim 11, wherein said inorganic material, as a cathode active material, is selected from a metal oxide, metal phosphate, metal silicide, metal selenide, transition metal sulfide, metal fluoride, metal chloride, or a combination thereof.

14. The lithium secondary battery of claim 11, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

15. The lithium secondary battery of claim 11, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

16. The lithium secondary battery of claim 12, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

17. A polymer composite separator for use in a lithium battery, the composite separator comprising (i) a thermally stable polymer; (ii) from 0.1% to 30% by weight of a lithium salt dispersed in the thermally stable polymer; and (iii) from 30% to 99% by weight of particles of an inorganic material wherein the particles are dispersed in or bonded by the thermally stable polymer and the composite separator has a thickness from 50 nm to 100 μm and a lithium ion conductivity from 10⁻⁸ S/cm to 5×10−² S/cm at room temperature and wherein the thermally stable polymer is selected from the group consisting of polyimide, poly(amide imide), poly(ether imide), aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polysuccinonitrile, polyquinolines, poly[2,2′-(m-phenylene)-5,5′-bibenzimidazole], poly(arylene ethers), polycarboranes, poly (p-xylylene), poly(phenylene ether), polymers from 1,4,5,8-naphthalenetetracarboxylic acid and aromatic tetraamines, poly(1,3,4-oxadiazoles), poly(1,2,4oxa-diazoles), poly(1,2,4- and 1,2,5-oxadiazole-N-oxides), polythiadiazoles, polypyromellitimidlnes, poly-1,3,4-thiazidazoie, poly(benzimidazobenzophenanthroline) ladders (BBL), poly(imidazoisoquinoline) ladders, polydicyclopentadiene (pDCPD), polyether ether ketone (PEEK), rigid-rod and ladder polymers, sulfonated versions thereof, and combinations thereof.

18. The polymer composite separator of claim 17, wherein said inorganic material comprises particles of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

19. The polymer composite separator of claim 17, wherein said inorganic material particles comprise a material selected from a transition metal oxide, aluminum oxide, silicon dioxide, transition metal sulfide, transition metal selenide, alkylated ceramic particles, metal phosphate, metal carbonate, or a combination thereof.

20. The polymer composite separator of claim 17, wherein the thermally stable polymer forms a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

21. The polymer composite separator of claim 17, wherein said inorganic material particles are non-uniformly distributed in the thermally stable polymer matrix in such a manner that a concentration of the inorganic material particles in one region of the polymer matrix is greater than a concentration of the inorganic material particles in another region.

22. The polymer composite separator of claim 17, wherein said lithium salt is selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃) , lithium bisperfluoro- ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid- based lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4.

23. A process for manufacturing the polymer composite separator of claim 17, the process comprising (A) dispersing particles of the inorganic solid material and said lithium salt in a liquid reactive mass of a polymer precursor to the thermally stable polymer to form a slurry; (B) dispensing and depositing a layer of said liquid reactive mass onto a solid substrate surface; and (C) polymerizing and/or curing said reactive mass to form said layer of polymer composite separator.

24. The process of claim 23, wherein said solid substrate is an anode current collector, an anode active material layer, or a cathode active material layer.

25. The process of claim 23, which is a roll-to-roll process wherein said step (B) comprises (i) continuously feeding a layer of said solid substrate from a feeder roller to a dispensing zone where said reactive mass is dispensed and deposited onto said solid substrate to form a continuous layer of said reactive mass; (ii) moving said layer of the reactive mass into a reacting zone where the reactive mass is exposed to heat, ultraviolet light, or high-energy radiation to polymerize and/or cure said reactive mass to form a continuous layer of polymer composite; and (iii) collecting said polymer composite on a winding roller.

26. The process of claim 24, further comprising cutting and trimming said layer of polymer composite into one or multiple pieces of polymer composite separators.

27. The process of claim 24, further comprising a step of combining an anode, said polymer composite separator, an electrolyte, and a cathode electrode to form a lithium battery.
